(19) United States
(12) Patent Application Publication
(10) Pub. No.: US 2026/0051744 A1
(43) Pub. Date: Feb. 19, 2026

(54) SIX-PHASE MOTOR-BASED ELECTRIC DRIVE INTEGRATING GALVANICALLY ISOLATED AC ON-BOARD CHARGER

(71) Applicant: FORD GLOBAL TECHNOLOGIES, LLC, Dearborn, MI (US)

(72) Inventors: Baoming Ge, Okemos, MI (US); Fan Xu, Novi, MI (US)

(21) Appl. No.: 18/802,648

(22) Filed: Aug. 13, 2024

(51) Int. Cl. H02J 7/14; B60L 50/51; B60L 50/61; H02J 7/02; H02M 7/537

(52) U.S. Cl. CPC H02J 7/14; B60L 50/51; B60L 50/61; H02J 7/02; H02M 7/537; B60L 2210/40; H02J 2207/20

(57) ABSTRACT

This document describes, among other things, a vehicle power system that includes a traction battery, a six-phase inverter divided into two groups of six switches, a six-phase motor, and a pair of switches. In drive mode, the switches configure the inverter to connect the traction battery and the motor. In plug-in mode, the system reconfigures so that one group of switches connects an AC source to the motor, while the other group connects the motor to the traction battery.

### TECHNICAL FIELD

This disclosure relates to automotive power systems.

### BACKGROUND

Electric vehicles and hybrid electric vehicles include components that work together to provide propulsion and energy management. These components include the traction battery, which stores electrical energy; the electric motor, which converts electrical energy into mechanical energy to drive the vehicle; and the inverter, which converts the DC power from the battery into AC power suitable for the motor. A power electronics system, including components such as converters and controllers, manages the flow of energy between the battery, motor, and other subsystems.

### SUMMARY

A vehicle includes a power system composed of a traction battery, a six-phase inverter with two groups of six switches, a six-phase motor, and a pair of switches. During drive mode, these switches are operated to electrically connect the two groups between the traction battery and the six-phase motor. During plug-in mode, one group of switches is electrically connected between an AC source and the six-phase motor, while the other group is electrically connected between the six-phase motor and the traction battery.

A method involves, during the plug-in mode of a vehicle, operating switches so that one group of six switches in a six-phase inverter is electrically connected between an AC source and a six-phase motor. Simultaneously, another group of six switches in the inverter is electrically connected between the six-phase motor and a traction battery. This configuration allows power to flow sequentially from the AC source through the first group of switches, the six-phase motor, and the second group of switches to the traction battery.

A vehicle power system comprises a traction battery, a six-phase inverter with two groups of switches, a six-phase motor, a pair of switches, and one or more controllers. These controllers are programmed to open the pair of switches during plug-in mode, enabling power from an AC source to flow sequentially through one group of switches, the six-phase motor, and the other group of switches to the traction battery.

### BRIEF DESCRIPTION OF THE DRAWINGS

FIG. 1 is a schematic diagram of a typical AC on-board charger.

FIGS. 2A-2C are schematic diagrams of a vehicle including a six-phase motor-based electric drive.

FIG. 3 is a block diagram of AC on-board charging power factor control.

FIGS. 4A-4B are block diagrams of inverter switch control.

FIG. 5 are plots of grid voltage and current.

FIG. 6 are plots of battery voltage and current.

FIG. 7 are plots of DC bus voltage and inductor current.

FIG. 8 are plots of six-phase motor winding currents.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

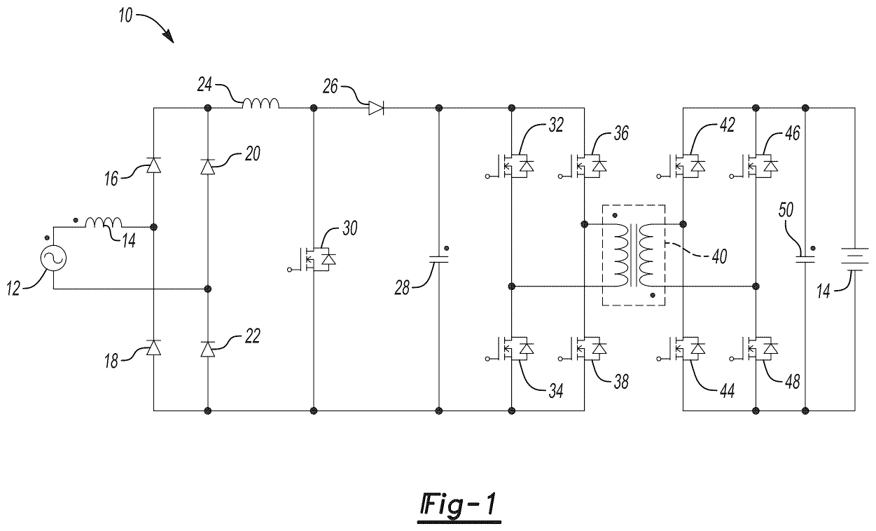

FIG. 1 illustrates an existing AC on-board charger 10 for electric vehicles and hybrid electric vehicles, designed to convert AC power from a grid 12 into DC power suitable for charging a traction battery 14. The system begins with input from the AC grid 12 that provides the necessary power, typically at a frequency of 50 Hz or 60 Hz. An inductor 14 is connected in series with the AC grid 12 to filter the input, reducing high-frequency noise and harmonics. Diodes 16, 18 are part of a full-bridge rectifier that, along with diodes 20, 22, converts the AC input into a pulsating DC voltage. Following the rectifier bridge, inductor 24 further filters the DC current, smoothing it to reduce ripple and provide a more stable output. Diode 26, connected in series with the inductor 24, ensures unidirectional current flow towards capacitor 28 and subsequent circuit stages.

The capacitor 28 is connected in parallel with the output of the diode 26. Switch 30 is a control switch connected across the inductor 24, used to manage power flow by disconnecting or connecting the inductor 24 from the negative busbar. Switches 32, 34, 36, 38 form a full-bridge inverter that converts the smoothed DC voltage back into high-frequency AC voltage, necessary for energy transfer and for the operation of high-frequency transformer 40. This transformer 40 provides galvanic isolation between the input and output circuits and steps up or steps down the voltage as needed.

On the secondary side of the high-frequency transformer 40, switches 42, 44, 46, 48 form another full-bridge rectifier that converts the high-frequency AC voltage back into DC voltage suitable for charging the traction battery 14. Capacitor 50, connected across the output of this rectifier, smooths the DC voltage to ensure a stable output for the traction battery 14. The traction battery 14, connected to the output of the charger, stores the converted DC power for use by the vehicle's electric drivetrain.

Such AC on-board chargers require space and have associated weight. A six-phase motor-based electric drive system is thus proposed that integrates a galvanically isolated AC on-board charger for electric vehicles and hybrid electric vehicles. A six-phase motor with two isolated neutral points is used. Unlike other systems that may use a three-phase open-end winding motor or a traditional motor with a single neutral point, the proposed design enables the motor to function as an isolation transformer during the AC on-board charging process. This capability eliminates the need for a 50 Hz or 60 Hz isolation transformer. Galvanic isolation is provided by the six-phase motor without the need for additional high-frequency transformers or dual active bridges typically required in conventional chargers.

The system operates in two distinct modes: vehicle driving mode and AC on-board charging mode. In vehicle driving mode, the AC grid is disconnected from the on-board charger, an active switch is turned off, and switches are closed. During this mode, the six-phase inverter drives the six-phase motor to propel the vehicle. The traction battery powers the motor through the inverter during motoring, and during regenerative braking, the generated power is sent back to the battery, allowing the system to function as a conventional electric drive.

In AC on-board charging mode, the vehicle is stationary, and the motor operates as a three-phase isolation transformer to provide necessary galvanic isolation. The AC grid connects to the input of the on-board charger, and the switches are opened. The control strategy in this mode includes managing the power factor correction (PFC) circuit and controlling other switches to maintain a constant DC bus voltage and achieve a unity power factor for the power grid. This involves generating sinusoidal control variables with specific amplitudes, frequencies, and phase angles. The amplitudes and phase angles of these variables are derived from the battery voltage, current, inverter fundamental frequency, and motor inductance.

The circuits in this system are constructed to facilitate switching between the two modes. In vehicle driving mode, the six-phase inverter and motor operate in a conventional manner, driving the vehicle and managing energy flow during motoring and regenerative braking. In AC on-board charging mode, the motor windings function as a high-frequency transformer, providing galvanic isolation without additional components. The PFC control method maintains a constant DC bus voltage while ensuring a unity power factor, and the switch control strategy enables efficient operation of the inverter.

Simulation results demonstrate the system's effectiveness in charging a 600V traction battery, with a charging current of 6.8 A (4 kW) and a grid current of 34.4 A rms. The power factor achieved is 0.9993, and the grid current total harmonic distortion (THD) is 3.3%. The six-phase motor currents display sinusoidal waveforms, indicating efficient power transfer and galvanic isolation.

A six-phase inverter is a power electronic device designed to convert DC into AC with six distinct phases, each phase shifted by 60 degrees. The six-phase inverter architecture typically includes two banks of switches, each controlling three phases of a motor. These switches, often implemented using insulated gate bipolar transistors (IGBTs) or metal-oxide-semiconductor field-effect transistors (MOSFETs), operate in a coordinated manner to produce the desired AC waveforms.

A possible advantage of a six-phase inverter lies in its ability to generate a smoother and more continuous torque output compared to traditional three-phase inverters. This can result in reduced torque ripple and lower harmonic distortion Additionally, the increased number of phases provides redundancy; in the event of a loss in one phase or switch, the system can continue to operate with the remaining phases.

The operation of a six-phase inverter involves control strategies to ensure timing and sequencing of the switches. Pulse-width modulation (PWM) techniques can be employed to modulate the switching signals, thereby controlling the amplitude and frequency of the output AC voltage. Other control algorithms, such as vector control or direct torque control, are used to optimize the performance of the motor drive, enabling dynamic response to varying load conditions.

PWM may involve adjusting the duration of the on-time of the inverter switches within each cycle to control the voltage and current supplied to the motor. By modulating these pulses, PWM creates an effective AC waveform from the DC input, allowing for control of the motor's speed and torque.

Vector control, also known as field-oriented control, goes a step further by decoupling the motor's torque and flux control. By transforming the three-phase currents into a two-axis system (d-q axes) using known mathematical transformations, vector control allows for independent control of the magnetic flux and torque-producing components of the current. This may result in faster dynamic response and better control of the motor's performance.

Direct torque control, on the other hand, directly regulates the motor's torque and magnetic flux by selecting appropriate voltage vectors from a predefined lookup table. Unlike vector control, direct torque control does not rely on transformations or coordinate systems but instead uses real-time feedback of the motor's torque and flux to make control decisions.

In practical applications, six-phase inverters may offer benefits in terms of power density and thermal management. By distributing the current load across six phases instead of three, the thermal stress on individual components is reduced.

A six-phase motor is a type of electric motor designed to operate with six distinct phases, each phase separated by 60 degrees. This motor configuration may provide several advantages over traditional three-phase motors, making it highly suitable for applications requiring high power density, enhanced performance, and redundancy. The six-phase motor includes six windings, often arranged in two groups, with each group having three phases. These windings are distributed evenly around the motor's stator to create a balanced magnetic field that drives the rotor.

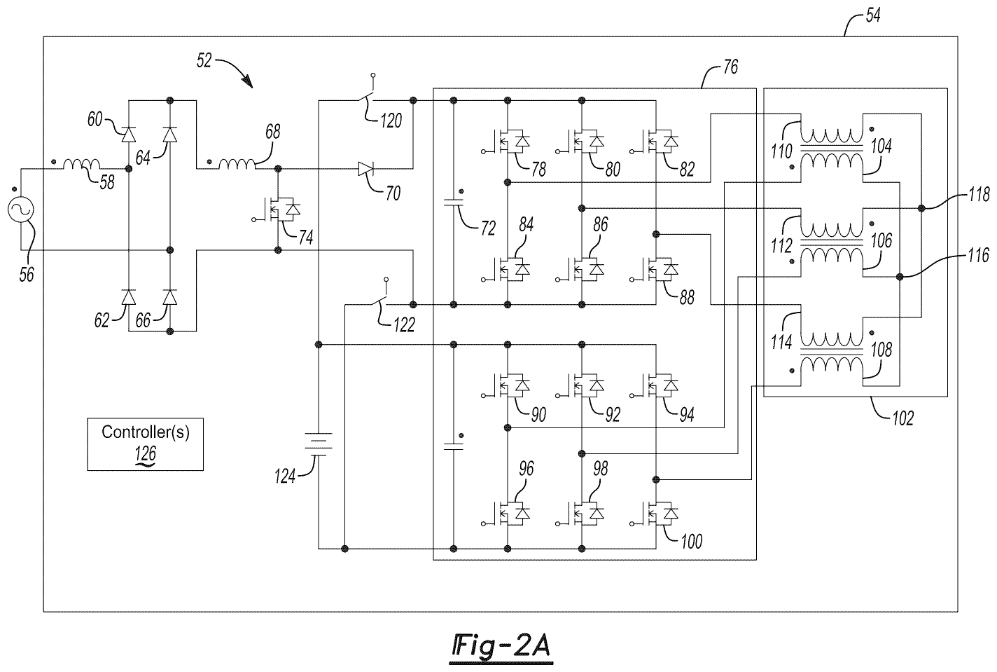

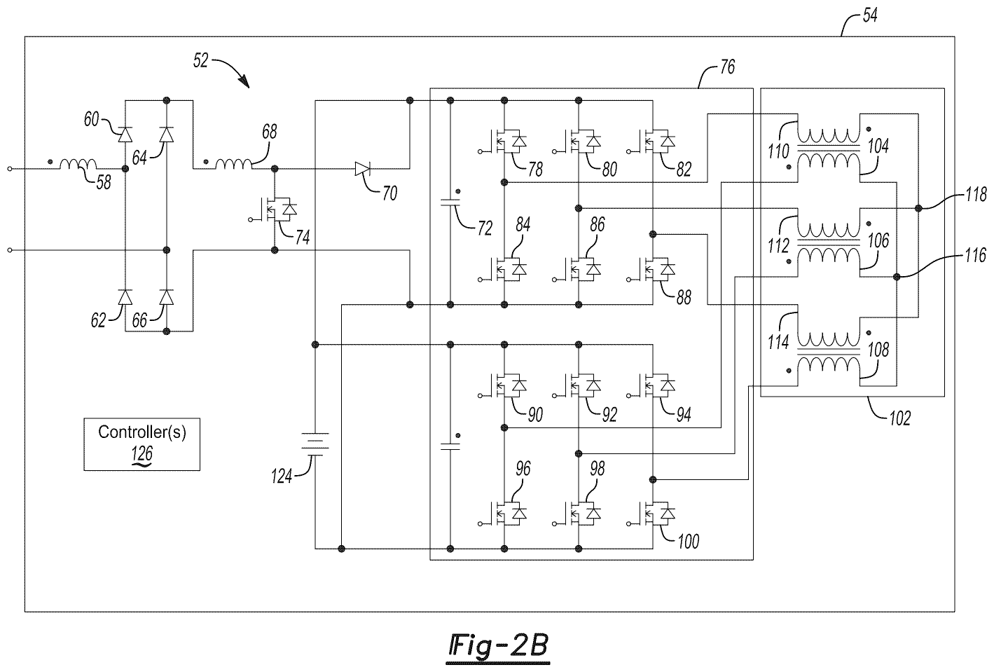

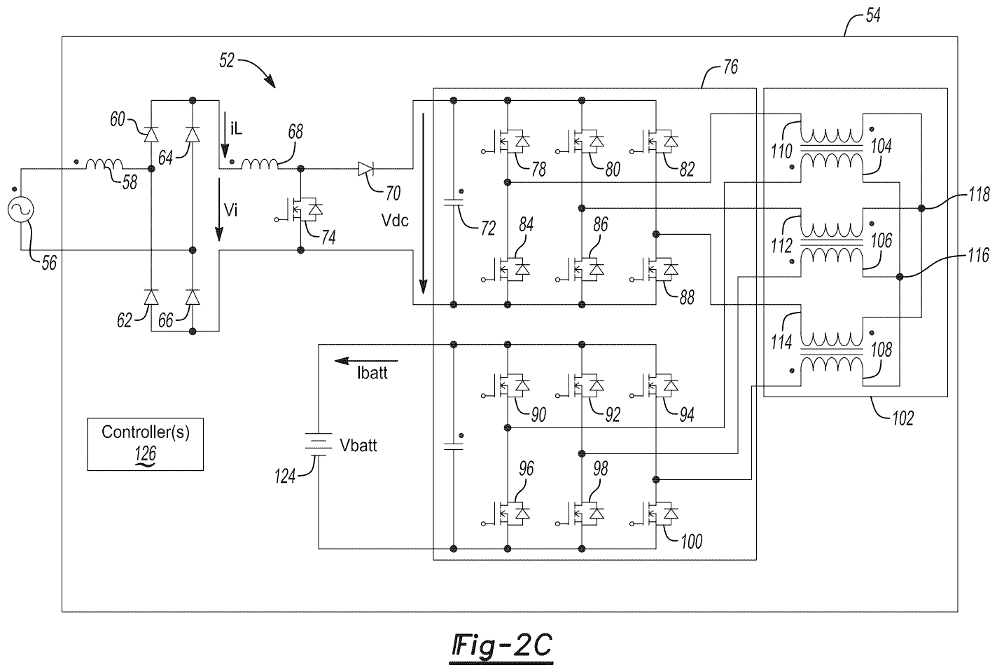

FIG. 2 represents a six-phase motor-based electric drive system 52 that integrates a galvanically isolated AC on-board charger for an electric vehicle or hybrid electric vehicle 54. Starting with an input from an AC grid 56 on the left side, the AC voltage is first filtered by an inductor 58, which helps in reducing high-frequency noise and harmonics. The filtered AC voltage is then rectified by a full-bridge rectifier composed of diodes 60, 62, 64, 66, converting the AC input into a pulsating DC voltage. Following the rectifier, inductor 68 smooths this DC current, reducing ripples and providing a more stable output. Diode 70 ensures unidirectional current flow, directing the current towards capacitor 72.

The capacitor 72, positioned parallel to the output of the diode 70 and inductor 68, further smooths the DC voltage. The system includes switch 74, which serves as a control element, managing the connection between the rectified DC output and the following stages. This DC voltage is then used by a six-phase inverter 76, which is composed of switches 78 through 100, divided into two groups. The first group includes switches 78, 80, 82, 84, 86, 88, while the second group comprises 90, 92, 94, 96, 98, 100. These switches convert the smoothed DC voltage back into high-frequency AC, necessary for driving six-phase motor 102.

The motor 102, depicted on the right side of the figure, includes windings 104, 106, 108, 110, 112, 114, which are connected to two isolated neutral points labeled 116, 118. This motor configuration enables the system to function as an isolation transformer during the AC on-board charging process, providing galvanic isolation without the need for additional transformers. Switches 120, 122 play a role in managing the operational mode of the system. When the vehicle 54 is in driving mode, the switches 120, 122 are closed, connecting traction battery 124 to the inverter 76 and enabling the motor 102 to propel the vehicle 54. In this mode, the AC grid 56 is disconnected, and the switch 74 is turned off.

In the AC on-board charging mode, the switches 120, 122 are opened, disconnecting the motor 102 from the drivetrain and allowing the windings 104, 106, 108, 110, 112, 114 to function as an isolation transformer. The AC grid 56 is connected through the rectifier and smoothing stages, and the inverter 76 converts the DC voltage to high-frequency AC. This high-frequency AC is then utilized by the windings 104, 106, 108, 110, 112, 114 to achieve galvanic isolation while charging the traction battery 124. The control strategy may include PFC to maintain a constant DC bus voltage and achieve a unity power factor.

Controller 126 is in communication with/exerts control over the components of the vehicle 54 and implements the techniques described herein. It may use automotive communication protocols such as CAN (Controller Area Network), LIN (Local Interconnect Network), and/or FlexRay to establish communication channels. These protocols enable the controller to send and receive data packets containing operational commands and status information. For instance, the controller 126 can send PWM signals to the inverter 76 to modulate the power supplied to the motor 102, adjusting its speed and torque. It also monitors sensors distributed throughout the vehicle 54 to collect data on parameters such as battery voltage, current, temperature, and motor position. This data can be processed in real-time using embedded algorithms to adjust the motor drive and battery management systems. Additionally, the controller 126 can manage the operation of other auxiliary systems, such as the heating, ventilation, and air conditioning system, regenerative braking system, etc.

Referring to FIG. 2B, during vehicle driving, there are several operations: 1) the AC grid 56 is disconnected from the AC on-board charger, 2) the switch 74 is turned off, and 3) the switches 120, 122 are closed. So, the system has the equivalent circuit shown and the AC on-board charger function does not work. The inverter 76 works to drive the motor 102 to propel the vehicle 54. The traction battery 124 delivers power to the motor 102 and vehicle 54 through the inverter 76 during motoring mode. The generated power is sent back to the traction battery 124 through the motor 102 and inverter 76 during generating mode. During this operation mode, the inverter 76 and motor 102 work in a conventional manner.

Referring to FIG. 2C, the vehicle 54 is not driven and the motor 102 works as a three-phase isolation transformer during the AC on-board charging mode. The AC grid 56 is connected to the input of the AC on-board charger and the switches 120 and 122 are open. The system has the equivalent circuit shown.

The control strategy for this operation mode includes PFC control, control of the switches 78-88, and control of the switches 90-100.

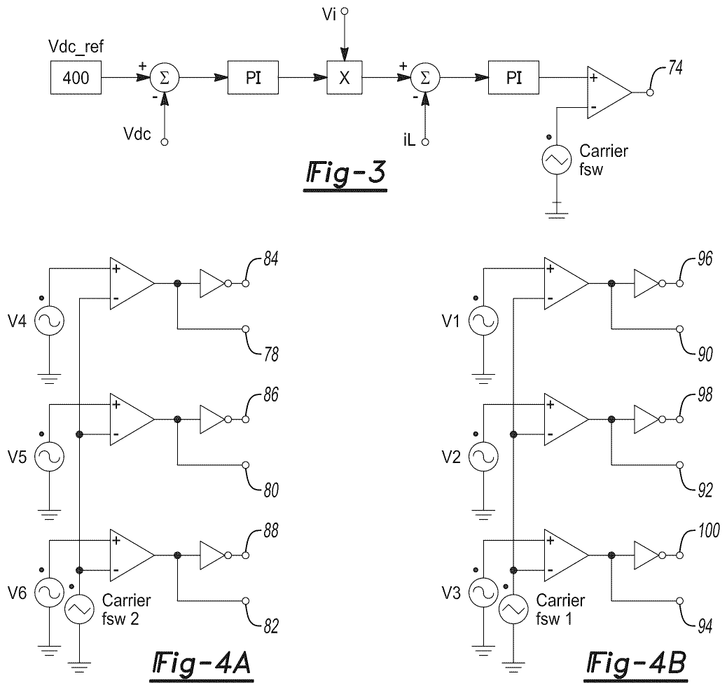

FIG. 3 shows the PFC control to maintain a constant DC bus voltage V_{dc} for the inverter consisting of switches 78-88, while achieving unity power factor for the AC grid 56. The control loop begins with a reference voltage V_{dc_ref}, which is set at 400V in this example. This reference voltage represents the desired output voltage level. The actual output voltage V_{dc} is fed back into the system and compared with V_{dc_ref} at the summing junction. The resulting error signal, representing the difference between the desired and actual voltages, is then passed through a proportional-integral (PI) controller. The PI controller adjusts the output to minimize the voltage error over time, effectively tuning the system to achieve the desired voltage level.

The output of the first PI controller is multiplied by the input voltage Vᵢ using a multiplier block. This step is performed to adjust the control signal based on the available input voltage. This adjusted control signal is then compared with the inductor current i_{L}, representing the current flowing through the system's inductor, at another summing junction. The difference between the adjusted control signal and the inductor current is again processed through a second PI controller.

The output of the second PI controller is fed into a comparator. The comparator also receives a high-frequency carrier signal fsw, which is associated with a PWM signal used in power electronics to control the switching of power transistors. The carrier signal and the output of the second PI controller are compared to generate the switching signal at output 74, which controls the state of the switch 74 in the power converter. The switch 74, when operated at the right frequency and duty cycle, ensures that the converter maintains the desired output voltage and current by adjusting the energy transfer to the output load.

FIGS. 4A and 4B show the basic control for the switches 78-88 and switches 90-100, respectively, where V1-V6 are the sinusoidal control variables with amplitudes, frequencies, and phase angles. Moreover, V1-V3 are symmetric in three phases, and V4-V6 are symmetric in three phases.

A factor to implement the control shown in FIGS. 4A and 4B is to get the amplitudes and phase angles of the V1-V6 variables. Define X=M₂V_{dc}, Y=M₁V_{batt}, then the amplitude M₁ of the V1-V3 variables is

$${M}_{1} = Y / {V}_{batt} \qquad ( 1 )$$

$$Y = {( {X}^{2} + 32 {( ω {LV}_{batt} {I}_{batt} )}^{2} / 9 {X}^{2} )}^{1 / 2} \qquad ( 2 )$$

The phase angle difference between V1 and V4 (or V2 and V5, or V3 and V6) is

$$∅ = {cos}^{- 1} X / Y \qquad ( 3 )$$

For the designed M₂ and V_{dc}, we can get M₁ and phase angle Ø from equations (1)-(3) based on battery voltage V_{batt}, current I_{batt}, inverter fundamental frequency ω, and motor inductance L. Finally, there are V1-V6 in (4) to control the switches 78-100 through FIGS. 4A and 4B for charging the traction battery 124. Of course, a closed-loop control system can be built to achieve the purpose of generating V1-V6, etc.

$$V 1 = {M}_{1} sin ( ω t - ∅ ) ; V 2 = {M}_{1} sin ( ω t - 120 ° - ∅ ) ; \\ V 3 = {M}_{1} sin ( ω t + 120 ° - ∅ ) ; \qquad ( 4 )$$

$$V 4 = {M}_{2} sin ( ω t ) ; V 5 = {M}_{2} sin ( ω t - 120 ° ) ; V 6 = {M}_{2} sin ( ω t + 120 ° )$$

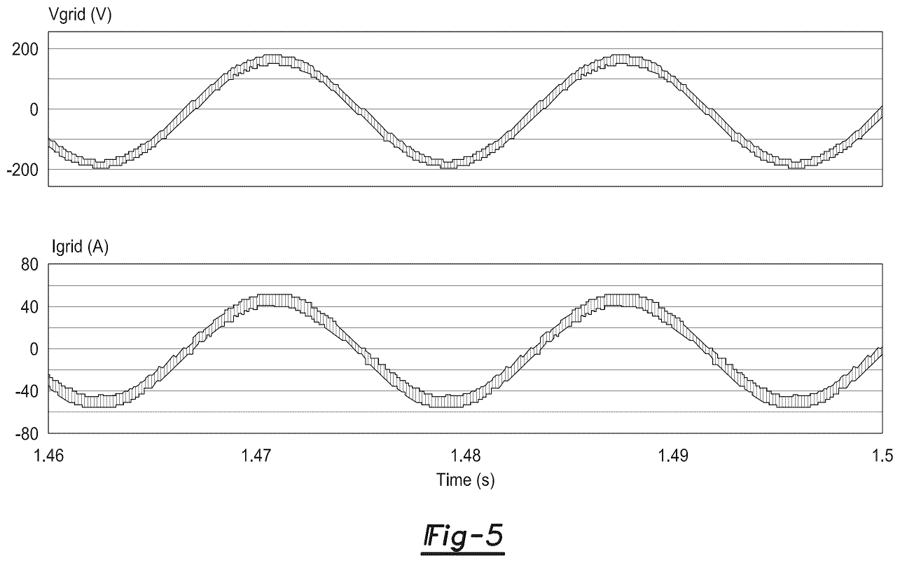

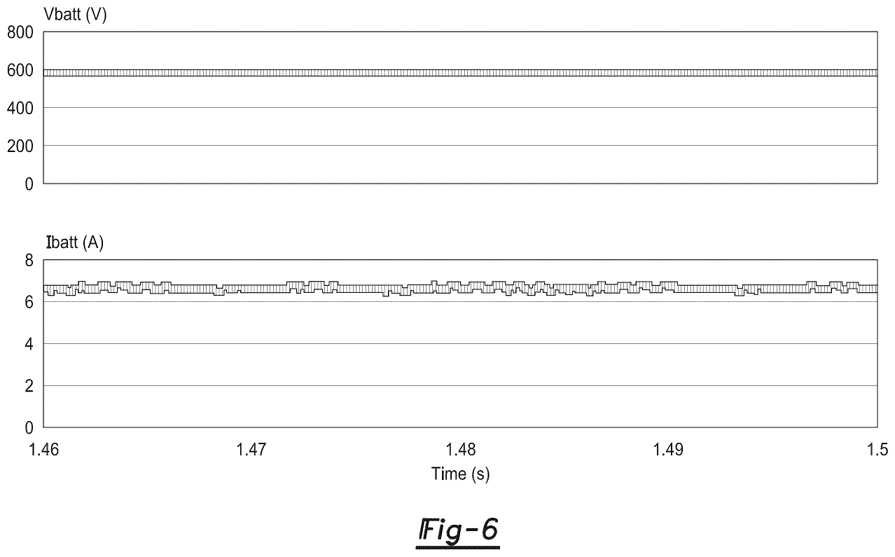

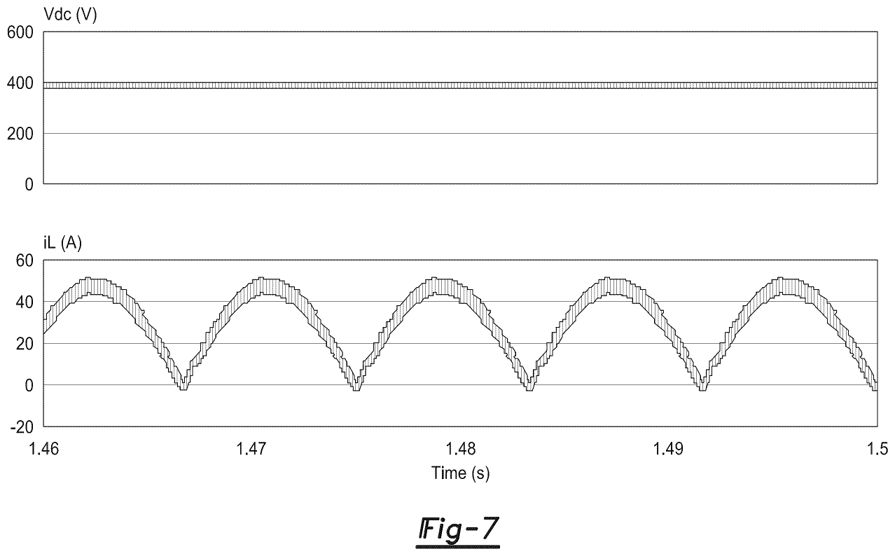

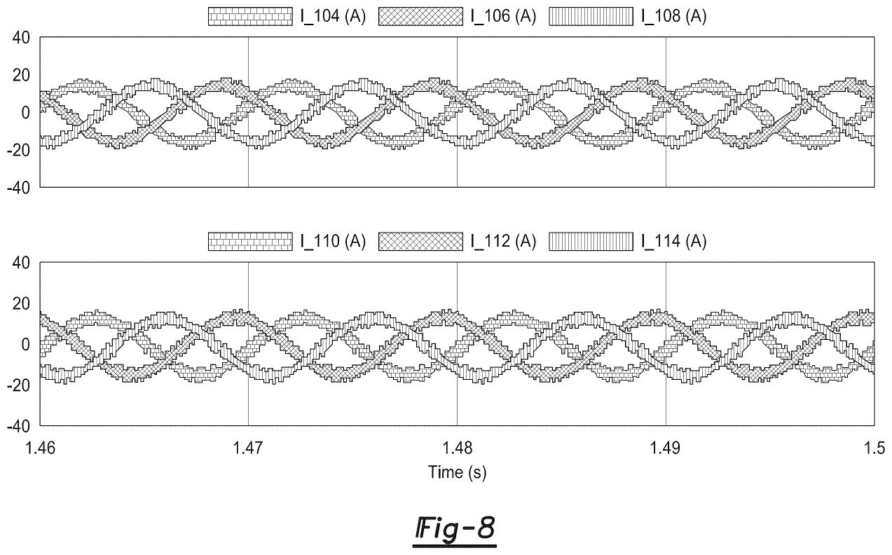

FIGS. 5-8 shows the simulation results when charging a 600V traction battery through the proposed AC on-board charger. In simulation, the AC power grid has 120V rms and 60 Hz, M₁=0.677, M₂=1, V_{dc}=400V. As shown in FIG. 6, traction battery charging current is 6.8 A (4 kW) and grid current is 34.4 A rms as shown in FIG. 5. Also, the power factor is 0.9993 and the grid current THD is 3.3%. Six phase currents show the sinusoidal waveforms in FIG. 8 and transfer power from the power grid to the traction battery, at the same time the six-phase motor achieves the galvanic isolation between the traction battery and power grid.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Controller” and “Controllers,” for example, can be used interchangeably herein as the functionality of one can be distributed across several, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a power system having a traction battery, a six-phase inverter including two groups of six switches, a six-phase motor, and a pair of switches that are configured to, during a drive mode, be operated such that the two groups are electrically connected between the traction battery and six-phase motor and, during a plug-in mode, be operated such that one of the groups is electrically connected between an AC source and the six-phase motor and the other of the groups is electrically connected between the six-phase motor and traction battery.

2. The vehicle of claim 1, wherein the six-phase motor includes windings configured to galvanically isolate the two groups during the plug-in mode.

3. The vehicle of claim 2, wherein the windings are further configured such that, during the plug-in mode, the six-phase motor operates as a three-phase isolation transformer.

4. The vehicle of claim 2, wherein the windings are connected to two isolated neutral points.

5. The vehicle of claim 1, wherein during the drive mode, the pair are closed.

6. The vehicle of claim 1, wherein during the plug-in mode, the pair are open.

7. A method comprising:
during a plug-in mode of a vehicle, operating switches such that one group of six switches of a six-phase inverter is electrically connected between an AC source and a six-phase motor and another group of six switches of the six-phase inverter is electrically connected between the six-phase motor and a traction battery to permit power from the AC source to sequentially flow through the one group, the six-phase motor, and the another group to the traction battery.

8. The method of claim 7, wherein the operating includes opening the switches.

9. The method of claim 7 further comprising, during a drive mode of the vehicle, operating the switches such that the groups are electrically connected between the six-phase motor and traction battery to permit power from the traction battery to flow through the six-phase inverter to the six-phase motor.

10. The method of claim 9, wherein the operating such that the groups are electrically connected between the six-phase motor and traction battery includes closing the switches.

11. A vehicle power system comprising:
a traction battery;
a six-phase inverter including two groups of switches;
a six-phase motor;
a pair of switches; and
one or more controllers programmed to open the pair such that power from an AC source flows sequentially through one of the groups, the six-phase motor, and another of the groups to the traction battery.

12. The vehicle power system of claim 11, wherein the one or more controllers are further programmed to close the pair such that power from the traction battery flows through the groups to the six-phase motor.

13. The vehicle power system of claim 11, wherein the six-phase motor includes windings configured to galvanically isolate the groups while the power flows sequentially through the one of the groups, the six-phase motor, and the another of the groups to the traction battery.

14. The vehicle power system of claim 13, wherein the windings are further configured such that the six-phase motor selectively operates as a three-phase isolation transformer.

15. The vehicle power system of claim 11, wherein each of the groups includes six switches.
